(19) United States
(12) Patent Application Publication
(10) Pub. No.: US 2019/0226647 A1
(43) Pub. Date: Jul. 25, 2019

(54) ON-OFF DIMMING AND COLOR-FIXING LAMP

(71) Applicant: ZheJiang Twinsel Electronic Technology Co.,Ltd., Ningbo (CN)

(72) Inventors: XueRen Zeng, Ningbo (CN); XueYi Zeng, Ningbo (CN); JianFei Ying, Ningbo (CN); ZhenZhong Kong, Ningbo (CN); RongQu Tang, Ningbo (CN); JiaWei Li, Ningbo (CN); RenJie Wang, Ningbo (CN)

(21) Appl. No.: 15/919,168

(22) Filed: Mar. 12, 2018

(30) Foreign Application Priority Data
Jan. 19, 2018 (CN) 2018200906753

(51) Int. Cl. F21K 9/238; F21V 23/04; F21V 23/00; F21V 23/02

(52) U.S. Cl. CPC F21K 9/238; F21V 23/04; F21Y 2115/10; F21V 23/02; F21V 23/003

(57) ABSTRACT

An on-off dimming and color-fixing lamp comprises a lampshade, a lamp holder, a control panel and a light source with a plurality of LED beads. The lampshade is connected with the lamp holder. The lampshade and the lamp holder form an accommodating cavity after connection. The control panel and the light source are both positioned in the accommodating cavity. The control panel comprises a control module, a power module and a drive module for driving the plurality of LED beads; the power module is electrically connected with the lamp holder, and the power module and the drive module are both electrically connected with the control module; and the light source is electrically connected with the drive module. The control panel also comprises a zero-pass detection module, and the zero-pass detection module is electrically connected with the control module. The plurality of LED beads can flash synchronously. The whole structure is simple. The preparation cost is low. A single LED bead or a plurality of LED beads can be switched on through the control module. The lamp can be used as a lighting lamp, an ornament during holidays, and a light supplementing lamp for plant growth. The lamp has high flexibility in use.

### BACKGROUND

### Technical Field

The invention relates to the technical field of novel LEDs, in particular to an on-off dimming and color-fixing lamp.

### Description of Related Art

Along with the significant development of LED technologies and their continuous cost reduction, on-off dimming and color-fixing lamps, as a branch of LED lighting, are greatly popular on the domestic Chinese, European, and American markets. The lamps used for lighting, ornamentation for holidays, and supplementing of light to plants for growth face increasing market demands and have a huge potential. However, the on-off dimming and color-fixing lamp in the prior art has a flashing function, but the plurality of LED beads disposed in the on-off dimming and color-fixing lamp cannot flash synchronously, thus generating a poor use effect.

### BRIEF SUMMARY

The technical issue to be settled in the invention is to provide an on-off dimming and color-fixing lamp with a good use effect.

The invention provides the following technical solution. An on-off dimming and color-fixing lamp includes a lampshade, a lamp holder, a control panel and a light source with a plurality of LED beads. The lampshade is connected with the lamp holder. The lampshade and the lamp holder form an accommodating cavity after connection. The control panel and the light source are both positioned in the accommodating cavity. The control panel includes a control module, a power module and a drive module for driving the plurality of LED beads; the power module is electrically connected with the lamp holder, and the power module and the drive module are both electrically connected with the control module; and the light source is electrically connected with the drive module. The control panel also includes a zero-pass detection module, and the zero-pass detection module is electrically connected with the control module.

Compared with the prior art, the invention with the above structure has the following advantages: a zero-pass detection module is configured to detect each cycle of the zero-pass signal of the sine wave of the alternating current and to send the detected signal as the base of the flashing frequency to the control module, thus ensuring that the plurality of LED beads can flash synchronously; moreover, the whole structure is simple, the preparation cost is low, and a single LED bead or the plurality of LED beads can be switched on through the control module; the on-off dimming and color-fixing lamp can be used as a lighting lamp, an ornament during the holidays and a light supplementing lamp for plant growth; and the on-off dimming and color-fixing lamp has high flexibility in use.

As an optimization, the plurality of LED beads are LED beads of various colors. The plurality of LED beads of various colors can meet different use demands, so that the invention has higher flexibility.

As an optimization, the on-off dimming and color-fixing lamp also includes a switch for switching the working states of the LED beads, and the switch is electrically connected with the control module. In this way, the working states of LED beads of different colors can be switched through control over the switch to meet the demands of different users.

As an optimization, the switch is a press signal switch. In this way, one switch can adjust the plurality of LED beads. Control is carried out according to the length of pressing the switch or the number of times of pressing the switch in a short time. The control is relatively convenient.

As an optimization, a cylindrical plastic connector is disposed between the lampshade and the lamp holder; one end of the plastic connector is connected with the lampshade, while the other end of the plastic connector is connected with the lamp holder; the control panel and the light source are both connected in the plastic connector, and the light source is positioned at one end of the plastic connector close to the lampshade. With such configuration, the control panel and the light source are conveniently installed, capable of improving productivity, eliminating the light-shading effect of the control panel on the lampshade, and improving the use effect of the user; moreover, the plastic connector also improves the insulation between the lamp holder and the control panel and between the lamp holder and the light source, thus preventing short-circuiting or breakdown to a higher extent.

### BRIEF DESCRIPTION OF THE SEVERAL VIEWS OF THE DRAWINGS

FIG. 1 is a connection block diagram of an on-off dimming and color-fixing lamp of the invention;

FIG. 2 is a structural view of the on-off dimming and color-fixing lamp of the invention; and

FIG. 3 is a circuit diagram of the on-off dimming and color-fixing lamp of the invention.

As shown in the drawings: 1. lampshade; 2. light source; 3. control panel; 4. plastic connector; 5. lamp holder; 6. cap nail.

### DETAILED DESCRIPTION

The invention is described in further detail below in conjunction with the attached drawings and specific embodiments, but the invention is not limited to the following specific embodiments.

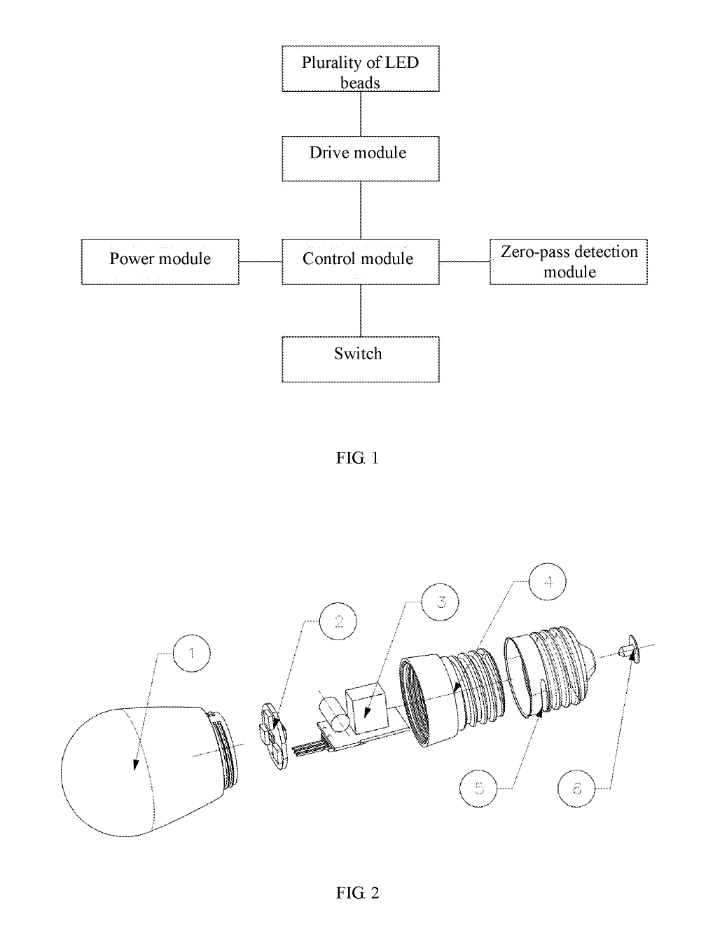

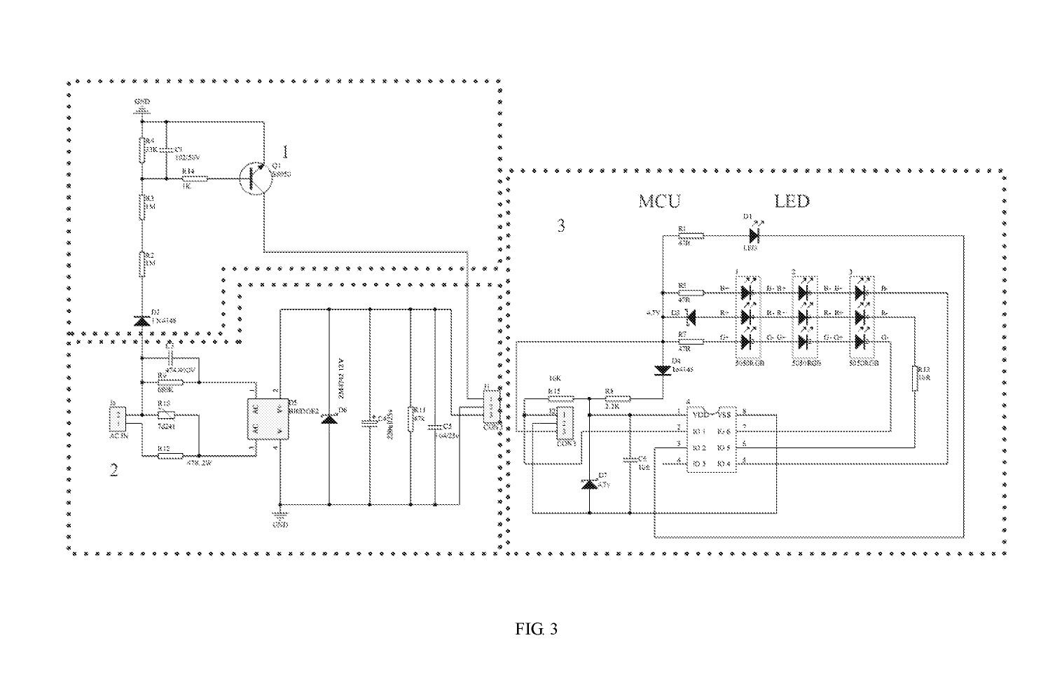

As shown in FIG. 1, FIG. 2 and FIG. 3, an on-off dimming and color-fixing lamp includes a lampshade 1, a lamp holder 5, a control panel 3 and a light source 2 with a plurality of LED beads. The lampshade 1 is connected with the lamp holder 5. Of course, a cap nail 6 is disposed at the rear end of the lamp holder 5. The lampshade 1 and the lamp holder 5 form an accommodating cavity after connection. The control panel 3 and the light source 2 are both positioned in the accommodating cavity. The control panel 3 includes a control module, a power module and a drive module for driving the plurality of LED beads; the power module is electrically connected with the lamp holder 5, and the power module and the drive module are both electrically connected with the control module; and the light source 2 is electrically connected with the drive module. The control panel 3 also includes a zero-pass detection module, and the zero-pass detection module is electrically connected with the control module.

The plurality of LED beads are LED beads of various colors.

The on-off dimming and color-fixing lamp also includes a switch for switching the working states of the LED beads, and the switch is electrically connected with the control module.

The switch is a press signal switch. The press signal switch is usually disposed on the plastic connector.

A cylindrical plastic connector 4 is disposed between the lampshade 1 and the lamp holder 5; one end of the plastic connector 4 is connected with the lampshade 1, while the other end of the plastic connector 4 is connected with the lamp holder 5; the control panel 3 and the light source 2 are both connected in the plastic connector 4, and the light source 2 is positioned at one end of the plastic connector 4 close to the lampshade 1.

After the on-off dimming and color-fixing lamp is electrified, the white LED beads among the LED beads light first. After the switch is pressed twice continuously, the control module detects the switching action and executes the next lighting command. Then, the red, green and blue LED beads in the lamp enter the automatically cycled flashing mode. The zero-pass detection module detects every cycle of the zero-pass signal of the sine wave of the alternating current, and sends the detected signal as the base of the flashing frequency to the control module, ensuring that a plurality of lamps can flash synchronously. After the switch is re-pressed twice continuously, the control module detects the switching action and executes the next lighting command. Then, the red, green, and blue LEDs in the lamp enter the fixed-color mode, which means that when the switch is pressed under the condition that the lamp is normally on, the current LEDs flash the LED colors and do not cycle any more. After the switch is continuously re-pressed twice again, the control module detects the switching action and executes the next lighting command. Then, the LEDs turn white. All functions cycle according to the above links.

This product integrates on-off dimming and color modulation technology and sine wave zero-pass detection technology from the power grid, realizing synchronous adjustment of the functions of color modulation, fixation and synchronous flashing of the LEDs of a plurality of lamps on the same circuit, and reducing cost. The on-off dimming and color-fixing lamp can be used as a lighting lamp, an ornament during holidays and a light supplementing lamp for plant growth. The product has novel functions, is conveniently controlled, has beautiful and elegant lighting effects, and greatly improves the use experience of users. After being launched, the product has been greatly poplar on the domestic and overseas markets, and presents a huge market value.

1. An on-off dimming and color-fixing lamp, comprising a lampshade, a lamp holder, a control panel and a light source with a plurality of LED beads; the lampshade being connected with the lamp holder; the lampshade and the lamp holder forming an accommodating cavity after connection; the control panel and the light source both being both positioned in the accommodating cavity, characterized in that the control panel comprises a control module, a power module and a drive module for driving the plurality of LED beads, wherein the power module is electrically connected with the lamp holder, the power module and the drive module are both electrically connected with the control module, the light source is electrically connected with the drive module; the control panel also comprises a zero-pass detection module, and the zero-pass detection module is electrically connected with the control module.

2. The on-off dimming and color-fixing lamp according to claim 1,
characterized in that the plurality of LED beads are LED beads of various colors.

3. The on-off dimming and color-fixing lamp according to claim 2, characterized by also comprising a switch for switching the working states of the LED beads, the switch electrically connected with the control module.

4. The on-off dimming and color-fixing lamp according to claim 3, characterized in that the switch is a press single switch.

5. The on-off dimming and color-fixing lamp according to claim 1, characterized in that a cylindrical plastic connector is disposed between the lampshade and the lamp holder; one end of the plastic connector is connected with the lampshade, while the other end of the plastic connector is connected with the lamp holder; the control panel and the light source are both connected in the plastic connector, and the light source is positioned at one end of the plastic connector close to the lampshade.

6. The on-off dimming and color-fixing lamp according to claim 1, characterized by also comprising a switch for switching the working states of the LED beads, the switch electrically connected with the control module.

7. The on-off dimming and color-fixing lamp according to claim 6, characterized in that the switch is a press single switch.
